(19) United States
(12) Patent Application Publication
(10) Pub. No.: US 2016/0073230 A1
(43) Pub. Date: Mar. 10, 2016

(54) SPATIO-TEMPORAL METHOD AND SYSTEM TO IMPLEMENT BOUNDARY REGULATION

(71) Applicant: Umm AI-Qura University, Makkah (SA)

(72) Inventors: Mohamed Abdur RAHMAN, Makkah (SA); Faizan Ur REHMAN, Makkah (SA); Saleh BASALAMAH, Makkah (SA)

(73) Assignee: Umm AI-Qura University, Makkah (SA)

(21) Appl. No.: 14/606,467

(22) Filed: Jan. 27, 2015

Related U.S. Application Data
(63) Continuation of application No. PCT/IB2014/002242, filed on Oct. 27, 2014.
(60) Provisional application No. 62/048,552, filed on Sep. 10, 2014.

(51) Int. Cl. H04W 4/02

(52) U.S. Cl. CPC H04W 4/021

(57) ABSTRACT

A boundary regulation detection method and system that stores one or more dates and times and predetermined areas corresponding to an event, determines a user current location and current date and time, generates an alert in response to determining that the current date and time corresponds with the date and time, analyzes whether the user current location is not within a predetermined area and sends to authorized individuals the user location. The method based on the current date, time and user location issues appropriate alerts.

### CROSS-REFERENCE TO RELATED APPLICATIONS

This application is a continuation application of PCT International Application No. PCT/IB2014/002242 filed Oct. 27, 2014, which claims priority to the U.S. Provisional Application 62/048,552, filed on Sep. 10, 2014, both of which are herein incorporated by reference in their entirety for all purposes.

### BACKGROUND

The usage of location aware devices has become widely spread due to their small size, low price and high precision. In many situations, a user location with respect to a specific area is needed for the generation of alerts or directions. In many applications, the boundary of the area is fixed and determined by certain laws or religion rituals. Users may also need assistance following boundary regulation such in pilgrimages. Friends and relatives may also need to check the user location. In addition, specific areas of the pilgrimage are also related to certain dates. Accordingly, it will be beneficial if the generated alerts are based on a date and location association and the users are presented with personalized alerts. Current pilgrimage guides do not offer personalized guidance.

The foregoing “background” description is for the purpose of generally presenting the context of the disclosure. Work of the inventor, to the extent it is described in this background section, as well as aspects of the description which may not otherwise qualify as prior art at the time of filing, are neither expressly or impliedly admitted as prior art against the present invention. The foregoing paragraphs have been provided by way of general introduction, and are not intended to limit the scope of the following claims. The described embodiments, together with further advantages, will be best understood by reference to the following detailed description taken in conjunction with the accompanying drawings.

### SUMMARY

The present disclosure relates to a boundary regulation implementation method that stores a list of events, stores one or more dates and times each corresponding to an event, stores one or more predetermined areas determined as a function of a particular event, determines a user location, determines whether a current date and time corresponds with a date and time stored in the memory, generates an alert based on the user location in response to determining that the current date and time corresponds with the date and time, analyzes whether the user location is within a predetermined area corresponding to the event indicated by the date and time, and sends to authorized individuals the user location.

A system for implementing boundary regulation is provided that includes storing in a server a list of events, storing one or more dates and times each corresponding to an event, storing one or more predetermined areas determined as a function of a particular event, determining a user location, determining whether a current date and time corresponds with a date and time stored in the memory, generating an alert based on the user location in response to determining that the current date and time corresponds with the date and time, analyzing whether the user location is within a predetermined area corresponding to the event indicated by the date and time, and sending to authorized individuals the user location.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a schematic diagram of boundary regulation detection system according to one example;

FIG. 2 is exemplary schematic maps showing different predetermined areas according to one example;

FIG. 3 is an exemplary flow chart of a system for boundary regulation detection illustrating a process of alerting the user according to one example;

FIG. 4 shows an exemplary table to store information corresponding to an event;

FIG. 5 is an exemplary flow chart of a system for boundary regulation detection according to one example;

FIG. 6 is an exemplary schematic of a predetermined area showing an alert zone according to one example;

FIG. 7 is an exemplary flow chart of a system for boundary regulation detection according to one example;

FIG. 8 is an exemplary flow chart of a system for boundary regulation detection according to one example;

FIG. 9 is an exemplary flow chart of a system for boundary regulation detection according to one example;

FIG. 10A is an exemplary user interface of a mobile device using a boundary regulation detection method according to one example;

FIG. 10B is an exemplary user interface of a mobile device using a boundary regulation detection method according to one example;

FIG. 11 shows user logs according to one example;

FIG. 12 is an exemplary flow chart to alert authorized individuals according to one example;

FIG. 13 is an exemplary flow chart to alert the authorized individuals according to one example;

FIG. 14 is an exemplary flow chart to alert the authorized individuals according to one example;

FIG. 15 is an exemplary flow chart to alert the authorized individuals about a user health status according to one example;

FIG. 16 is an exemplary user interface of the mobile device; and

FIG. 17 is an exemplary block diagram of a server according to one example.

### DETAILED DESCRIPTION

Referring now to the drawings, wherein like reference numerals designate identical or corresponding parts throughout several views, the following description relates to a boundary regulation detection system and associated methodology for determining when a user has entered a predetermined area and for generating appropriate alerts to guide the user. In addition, the system may send notifications to authorized individuals about the user location and health status.

Specially, as shown in the drawings and related discussion, when a current date and time corresponds to a specific date and time, the system may check the user location and based on the user location it can issue appropriate alerts. The system may display, for example, directions to the predetermined area, where the user should be during the specific date and time corresponding to the current date and time. Additionally, the system may continuously monitor the user location to prevent him from leaving the predetermined area by alerting the user if the distance between the user location and a boundary becomes smaller than a preset threshold distance. An alert may be a visual and/or audible alert. The system may send the alert to an external device. In selected embodiments, the external device may be a mobile device. In one embodiment, the method may be directed towards religious pilgrimages such as the Hajj pilgrimage. The Hajj pilgrimage is one of the most important pillars of Islam. Each pilgrim has to follow a set of rules to stay in the predetermined area at the specific date and time. For example, pilgrims have to stay in the predetermined area “Arafat” from afternoon to sunset on the ninth of “Zil-Hijjah” the 12^{th} month of Hijri calendar. The users of the system may be the pilgrims performing the Hajj. In one example, the specifics dates include the 8^{th}, 9^{th}, 10^{th}, 11^{th}, 12^{th} and 13^{th} day of the 12^{th} month of Hijri calendar.

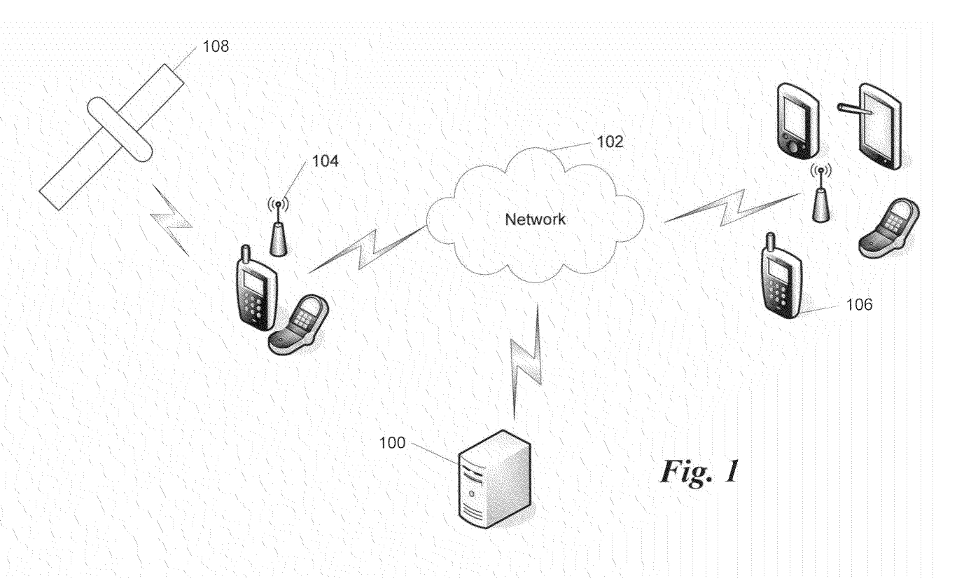

FIG. 1 shows a schematic diagram of the boundary regulation detection system according to an exemplary embodiment. In FIG. 1, the mobile device 106 is connected to a server 100 via a network 102. The mobile device 106 represents one or mobile devices connected to the server 100 via the network 102. The network 102 is any network that allows the mobile devices and servers to communicate information with each other over computer networks. The server 100 is one or more servers that responds to requests across a computer network and generates the alerts. The mobile device 106 communicates with the server 100 via the network 102. The mobile device 106 may also communicate with the server 100 via a satellite 108. The server 100 receives information about the mobile device location. The server 100 stores predetermined areas and dates list.

The mobile device 106 location can be determined via various satellite 108 based positioning systems known in the art, as GPS (Global Positioning System). For example, the mobile device 106 can include a location detector. The location detector may be a GPS module to detect a current geographical location of the mobile device 106. In other embodiments, the mobile device location is determined via a cellular tower 104 with which communication has been established using current technologies such as GSM (Global System for Mobile) localization, triangulation, blue-tooth, hotspots, WiFi detection, or other methods as would be understood to one of ordinary skill in the art. In other embodiments, the mobile device location is determined by the network 102. In particular, it may detect a location of the mobile device 106 as a network address on the network 102. The mobile device location corresponds to the user location. Once the mobile device location is determined by any of the techniques described above or other method as known in the art, the user location is likely known. Then in response to a query from the server 100, the mobile device 106 sends the user location to the server 100 via the network 102. The mobile device 106 location may be checked periodically every 1 minute, 5 minutes or any other suitable period. In other embodiments, the mobile device 106 location may be checked only during the specific date and time of interest. As described further below, the mobile device 106 may connect with the server 100 to receive the alerts based on the mobile device 106 location. In selected embodiments, the server 100 may automatically send the alerts to the mobile device 106 via the network 102.

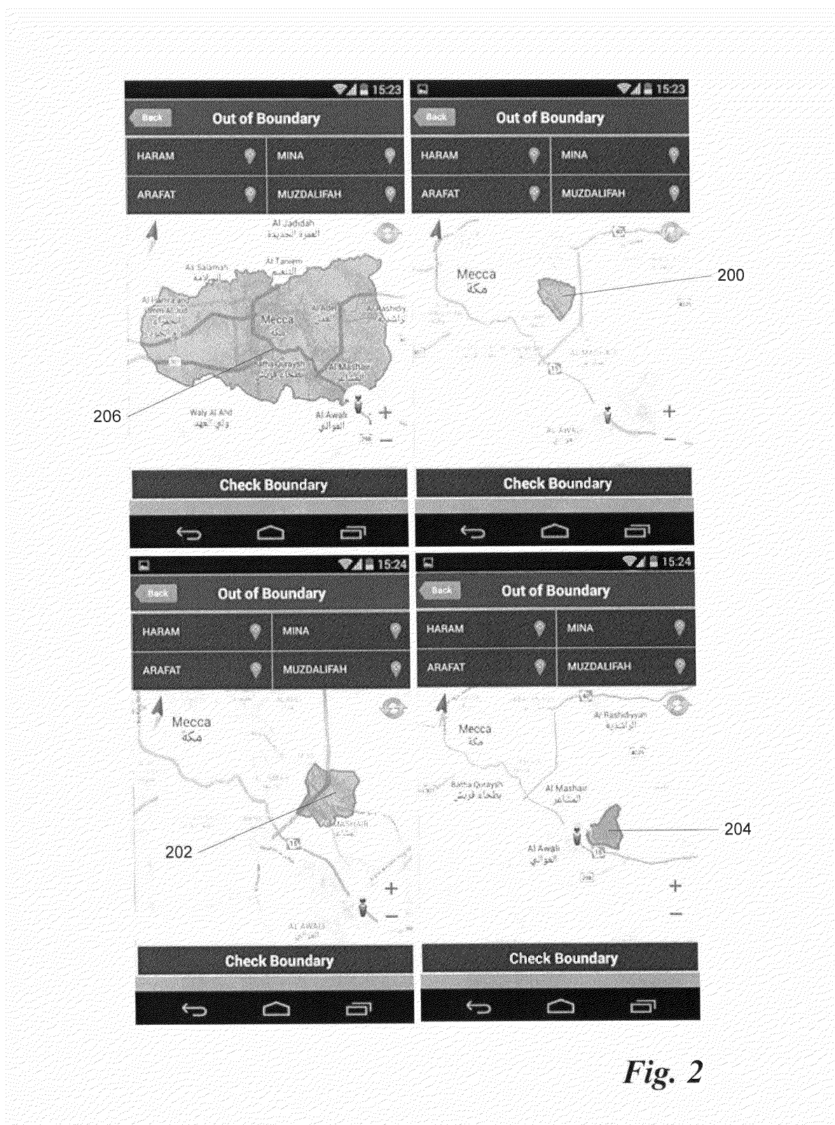

FIG. 2 shows exemplary maps with various predetermined areas highlighted. In one embodiment, the areas boundaries and locations may be as strictly defined in Islamic laws. The predetermined areas include “Mina” 200, “Muzdalifah” 202, “Arafat” 204, and “Haram” 206. The boundary of the predetermined area may be stored in the server 100 in terms of a set of latitude and longitude coordinates. In another embodiment, the set of latitude and longitude coordinates is stored in a memory of the mobile device 106. The boundary may be also defined by GPS coordinates or other coordinates depending on the system used. The mobile device 106 may also connect to the server 100 via the network 102 to verify that the coordinates stored in the memory of the mobile device 106 is up to date. The server 100 may communicate changes in the area boundaries and locations to the users via the network 102. In selected embodiments, the area boundaries and locations are based on athletic events such as marathons. The server 100 may then send the alerts to user to inform them about restricted areas during the athletic event depending on the time of the day. For example, street A may be closed for traffic for a certain duration.

In selected embodiments, the server may receive via communication circuitry information indicating an emergency in a specific area. A different area boundary coordinates may be uploaded to the server 100 via the network 102 by a third party. The different area location and boundary may be downloaded automatically to the mobile device 106 from the server 100 via the network 102. The server may analyze whether the user location is within the specific area. The server 100 may generate instructions to a designated user to go to the different area upon determining that the designated user is within the specific area. In one example, the emergency may be a catastrophic event such as an earthquake. The third party may be government officials or organizers of the event. The different area boundary may be time specific. The boundary coordinates for the different area and alert may be valid for a specific duration. Many different areas may also be generated. Depending on the designated user current location, the alert may be specific to each individual user to send him to the nearest different area. After the catastrophic event, the user of the mobile device 106 may connect to the server 100 via the network to check if the alert has been generated.

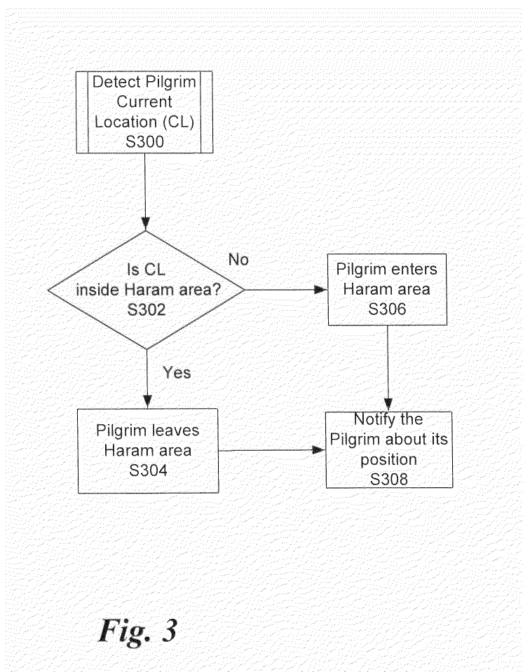

FIG. 3 is an exemplary algorithmic flowchart of the boundary regulation detection method. At step S300, the user location is detected based on the location of the mobile device 106 and transmitted to the server 100 via the network 102. At step S302, the server 100 checks if the user location is inside the predetermined area by checking if the longitudinal and latitude coordinates of the user location are inside the predetermined area. The predetermined area can correspond to, for example, “Haram” 206. At step S304, if the user location is inside the predetermined area then the server 100, based on the location data from mobile device 106, may track the mobile device 106 and in response to the mobile device 106 leaving the predetermined area the flow proceeds to step S308. At step S304, if the user location is outside the predetermined area the flow proceeds to step S306. At step S306, in response to the user entering the predetermined area the flow proceeds to step S308. At step S308, the user is notified about its current location.

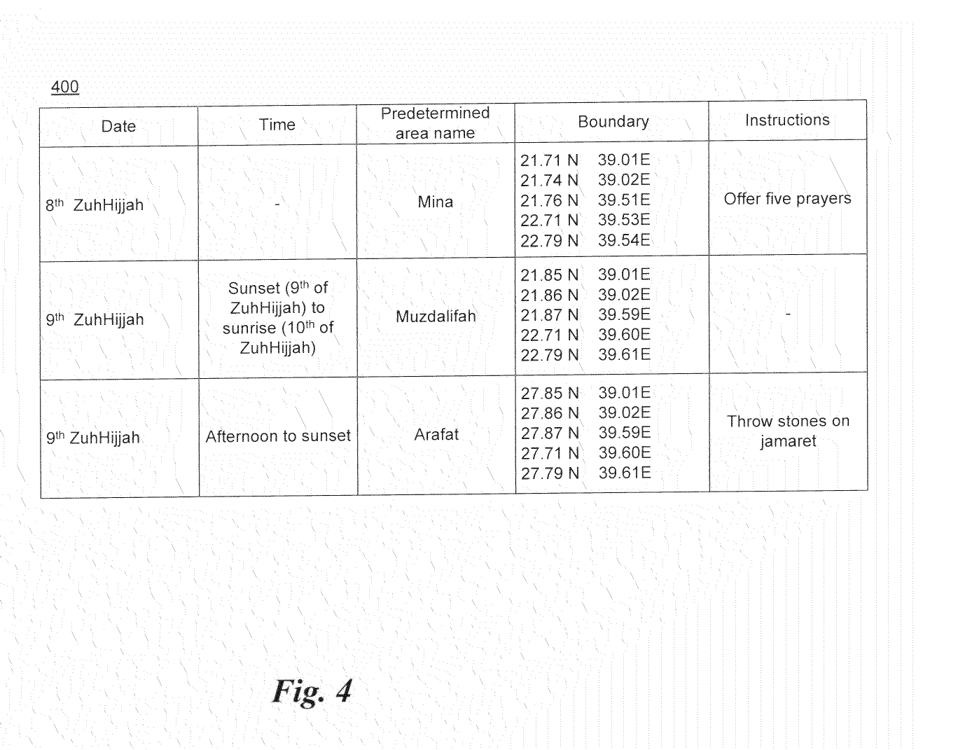

FIG. 4 shows an exemplary table to store information corresponding to an event. The information may include one or more date and times, one or more predetermined areas, a predetermined area boundary corresponding to the event. In selected embodiments, the event may be a religious event such as Hajj or Umrah. The event may extend over multiple days such in the case of Hajj. In other embodiments, the event may be a single day event such as Christmas day. In selected embodiments, the table may also include instructions corresponding to the event. The instructions may be religious rituals. For example, the instructions may describe the religious rituals that have to be performed at the predetermined area corresponding to the date and time. For example, table 400 shows that for the predetermined date “8^{th} Zil el Hijjah”, the predetermined area name is “Mina” and the instructions is to “offer five prayers”. The table 400 may be stored in the memory of the mobile device 106. In other embodiments, the table 400 may be stored in the server 100. The table 400 may be updated by the third party.

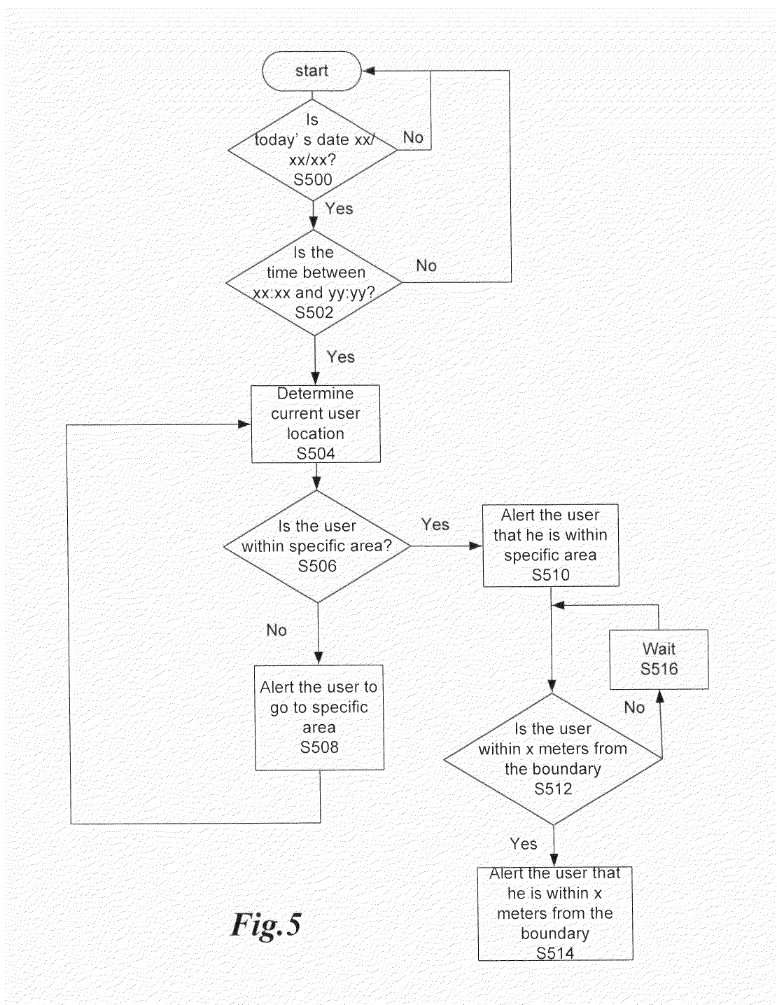

FIG. 5 is an algorithmic flowchart illustrating a method for monitoring the user location and generating the alert if the user gets within the preset threshold distance from the boundary. The current date is determined at step S500. The current date may be compared with the specific date's list to determine whether the current date is a specific date such as the 8^{th} of the 12^{th} month of Hijri. In one example, the specific dates are stored in the server 100. At step S502, if the current date matches the specific date, the current time is determined. The server 100 checks if the current time is within a time range. In another example, the specific time may be specified as daytime. In another example, the specific time may be determined by sunset or sunrise thus the server 100 may obtain the sunset time for the specific date and then compare it with the current time. For example, the server 100 may determine that the sunset for June 11 occurs at 8:33 pm at the predetermined area. In one example, the current date and time may be obtained from the device internal clock. In one example, the date list and time corresponds to specific dates in Hajj rituals based on Islamic laws. At step S504, if the current time is within the time range the user location is detected. An example of determining the user location is to detect the mobile device 106 location as described above in conjunction with the cellular tower 104. At step S506, the server 100 determines if the user location is within the predetermined area corresponding to the specific date and time. For example, the server 100 may determine that for the current date 8^{th} Zil-El-Hijjah the user current location 21.72N, 39.20E is within the boundary of “Mina” as specified in table 400. At step S508, if the user location is not within the predetermined area, the server 100 generates the alert to instruct the user to go to the predetermined area corresponding to the date and time. For example, the alert may instruct the user to go to “Mina”. In one example, the mobile device 106 displays the alert via a display screen. At step S510, when the user is within the predetermined area, the user is notified that he is within the predetermined area corresponding to the current date and time. In another example, the server 100 may alert the third party via the network 102 that the user is not in the predetermined area. The third party may dispatch guides to help the user get to the predetermined area.

At step S512, the server calculates the distance between the user location and the predetermined area boundary. If the calculated distance is smaller than the preset threshold distance, the system may issue the alert at step S514. The preset threshold distance (e.g., 1 meter) may be preregistered in the server 100. The preset threshold distance may be setup according to the user preference. The preset threshold distance may vary from 1 meter to 2 kilometer. In other embodiments, the preset threshold distance may be dependent on the mode of transportation of the user. For example, if the user is walking, the preset threshold distance may vary from 1 meter to 10 meter while if the user is using a car the preset threshold may vary from 1 kilometer to 2 km. The preset threshold distance is chosen in such a way to give the user enough time to respond to the alert. In selected embodiments, the preset threshold may depend on the accuracy of the localization method used to determine the user location. For example, if the localization method used has an error margin of 2 meters then the preset threshold may be set to 1 meter. In selected embodiments, the alert may be accompanied by a sound. The volume of the sound may depend on the distance from the user current location and the predetermined area boundary. The closer the user current location is to the predetermined area boundary the higher volume. The alert may inform the user of the distance between the location of the mobile device 106 and the boundary (e.g., 1 meter) and that the user is about to leave the predetermined area. In other embodiments, the mobile device may further alert the user if he is walking towards or away from the boundary.

If the distance is greater than the preset threshold distance then the user location is checked at step S512 after a wait has been performed at step S516. An example of performing the wait is to wait a predetermined period, such as one second. In selected embodiments, the device can detect movement via a motion sensor such as an accelerometer and then proceed to step S512. In other word, in order to conserve battery power the mobile device 106 location may be determined only once it has been determined that the mobile device 106 is moving. In selected embodiments, the accelerometer must detect a motion greater than a predetermined threshold distance to avoid false movement alert when the accelerometer detects a small motion. For example, the user may be changing the location of the mobile device 106 on a table and thus the mobile device location should not be checked in this case.

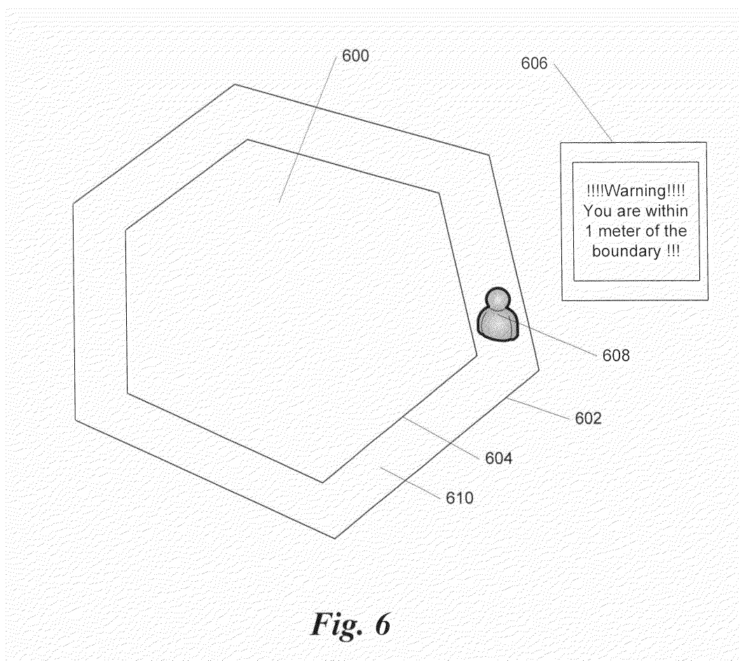

FIG. 6 shows a predetermined area 600 with its boundary 602. 604 represents a threshold boundary. The threshold boundary 604 is obtained by taking an offset from the boundary equal to the preset threshold distance. An alert zone 610 is defined as the area between 602 and 604. The preset threshold distance can be personalized or set up for a group of users. When the user 608 is in the alert zone 610 the alert 606 is generated by the server 100 as described above. In one example, the alert 606 text may be “Warning! You are within 1 meter of the boundary”. In another example, if the user is deliberately leaving the predetermined area then the alert may be dismissed by the user.

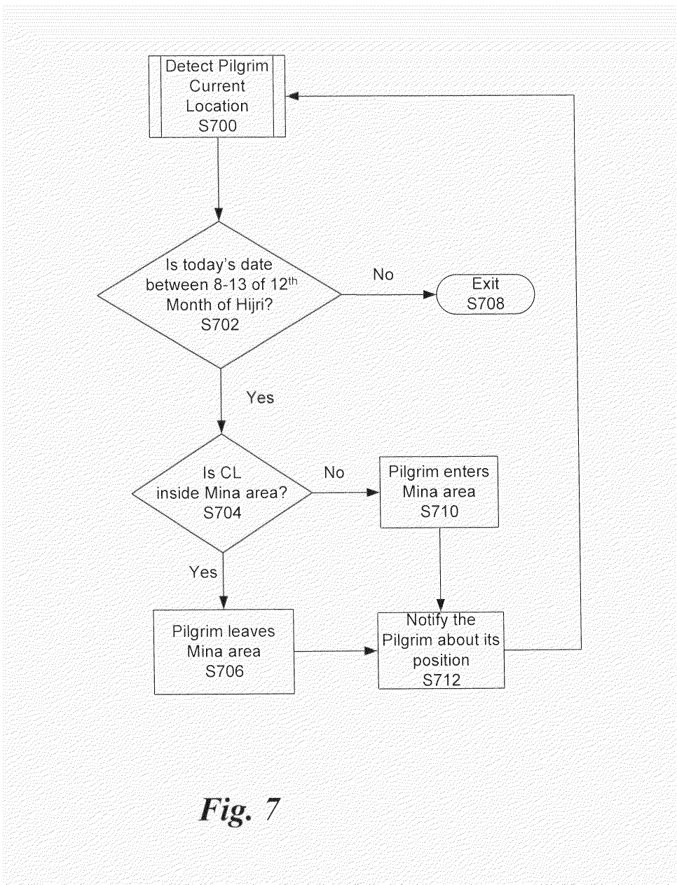

FIG. 7 is an exemplary flowchart of a system to alert the user about his current location. At step S700, the user location is detected. This may be done using any method known in the art such as GPS and triangulation. At step S702, today's date is checked, in one example, if it is between the 8^{th} to 13^{th} from the 12^{th} month of Hijri. Then if the server 100 determines that the current date is one of the specific dates, the step proceeds to step S704. Accordingly, the server 100 compares the current date to previously stored dates, the dates each having an associated event and boundary data of the event. For example, if the current date is 9^{th} Zil el Hijjah, then the processing circuitry may determine using techniques such as text matching that the current date is one of the specific date as illustrated in table 400. If the server 100 determines that the current date is not one of the specific dates, the step proceeds to S708. At step S704, the server 100 checks whether the user location (determined at step S700) is inside the predetermined area “Mina”. If the user location is inside the predetermined area “Mina”, the step goes to step S706. If the user location is not inside the predetermined area “Mina”, the step goes to S710. At step S706, when the user leaves the predetermined area “Mina” the step proceeds to S712. At step S710, when the user enters the predetermined area “Mina” the flow proceeds to step S712. At step S712, the user is notified about its current location. Upon determination that the mobile device 106 has entered the predetermined area, the mobile device 106 may display information about the predetermined area. The information can also be stored with the event data. In selected embodiments, the information may be the religious instructions. In one example, the device may display the rituals that need to be performed at the predetermined area. In selected embodiments, the information may be user specific. The mobile device 106 may display only the information pertaining to the user. For example, the information may be age dependent. For example, certain rituals may only need to be performed by adults. The server 100 may check the user personal information to determine if the user is an adult and thus must perform the rituals stored in table 400 associated with the predetermined area.

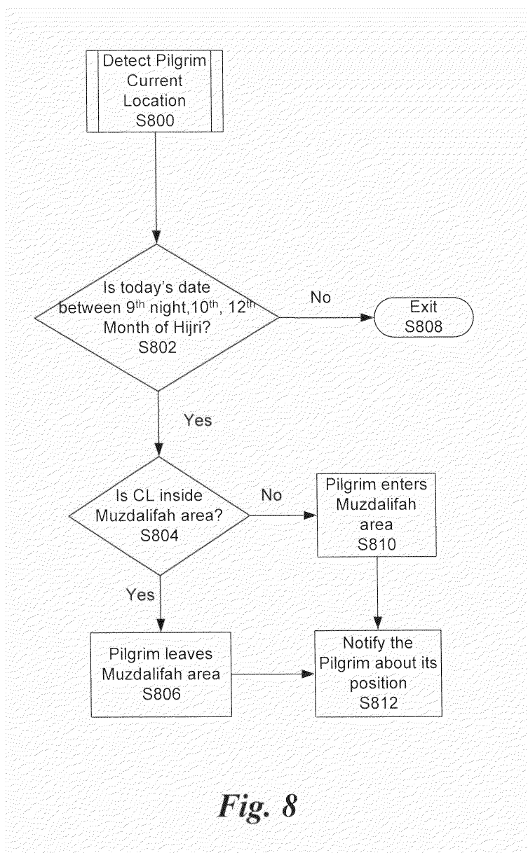

FIG. 8 is another exemplary flowchart to alert the user about his current location. At step S800, the user location is detected. At step S802, today's date is checked, in one example, if it is between the 9^{th} nighttime to the 10^{th} from the 12^{th} month of Hijri. Then if the server 100 determines that the current date is one of the specific dates, the step proceeds to S804. If the server 100 determines that the current date is not one of the specific dates, the step proceeds to S808. At step S804, the server 100 checks whether the user location (determined at step S800) is inside the predetermined area “Muzdalifah”. If the user location is inside the predetermined area “Muzdalifah” the steps goes to step S806. If the user location is not inside the predetermined area “Muzdalifah”, the step goes to step S810. At step S806, when the user leaves the predetermined area “Muzdalifah” the flow proceeds to step S812. At 810, when the user enters the predetermined area “Muzdalifah” the flow proceeds to step S812. At step S812, the user is notified about its current location.

The server 100 may send alerts to all users or in selected embodiments to a group of users. The users may be grouped based on their location. The server 100 may send information to the group of users based on their location and time. The server 100 may send the alert to the group of users that they can leave a certain area and proceed to the next area. In pilgrimage this features can be used to control the user and avoid injuries due to stampede. Each member of the group may send information to one or more member of the group via the network 102.

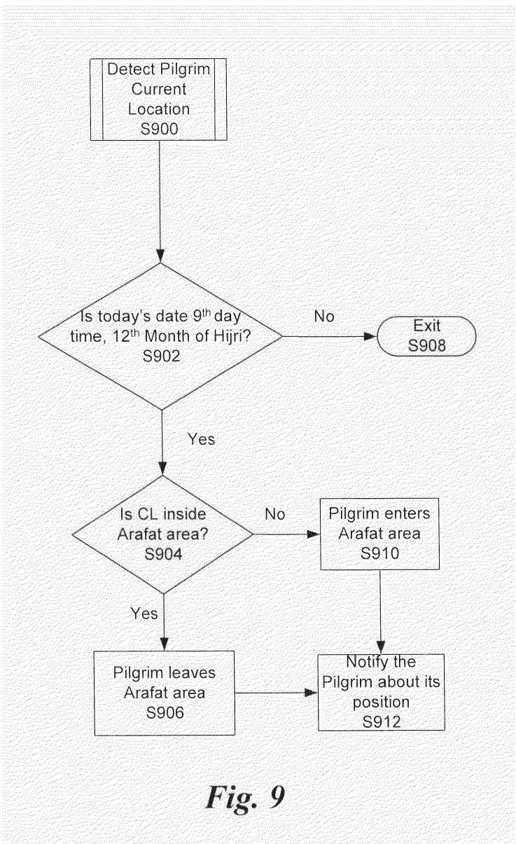

FIG. 9 is another exemplary flowchart to alert the user about his current location. At step S900, the user location is detected. At step S902, today's date is checked, in one example, if it is the 9^{th} daytime of the 12^{th} month of Hijri. Then if the server 100 determines that the current date is one of the specific dates, the step proceeds to step S904. If the server 100 determines that the current date is not one of the specific dates, the step proceeds to step S908. At step S904, the server 100 checks whether the user location (determined at step S900) is inside the predetermined area “Arafat”. If the user location is inside the predetermined area “Arafat”, the step goes to step S906. If the user location is not inside the predetermined area “Arafat”, the flow goes to step S910. At step S906, when the user leaves the predetermined area “Arafat” the flow proceeds to step S912. At step S910, when the user enters the predetermined area “Arafat” the flow proceeds to step S912. At step S912, the user is notified about its current location.

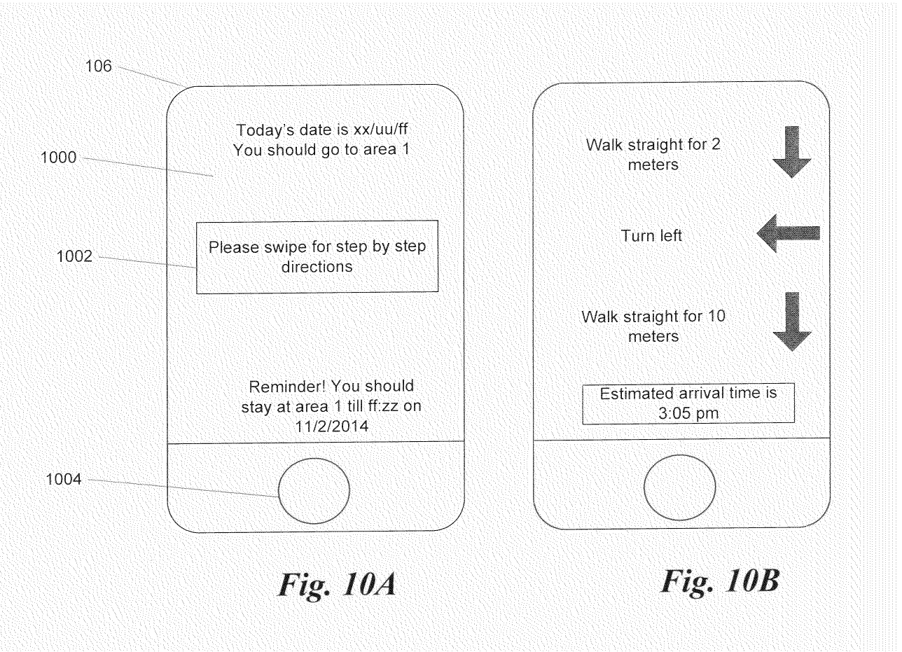

FIG. 10a is a diagram illustrating an exemplary user interface of a mobile device 106 using the boundary regulation detection method. The mobile device 106 may be, for example, a tablet, a personal digital assistant, a cellular telephone or a smart phone. In one example, the mobile device 106 may include a touchscreen 1000 and a button 1004. The mobile device 106 may display the alert received from the server 100 via the internet 102. A user interaction with the alert may be received through the touchscreen 1000 or the button 1004. Processing the user interaction may include dismissing the alert, accepting or following the instructions displayed on the touchscreen 1000. In the example shown, the user is instructed to swipe 1002. FIG. 10b shows an exemplary display of step-by-step directions following the user interaction. In another example, the directions could be audible.

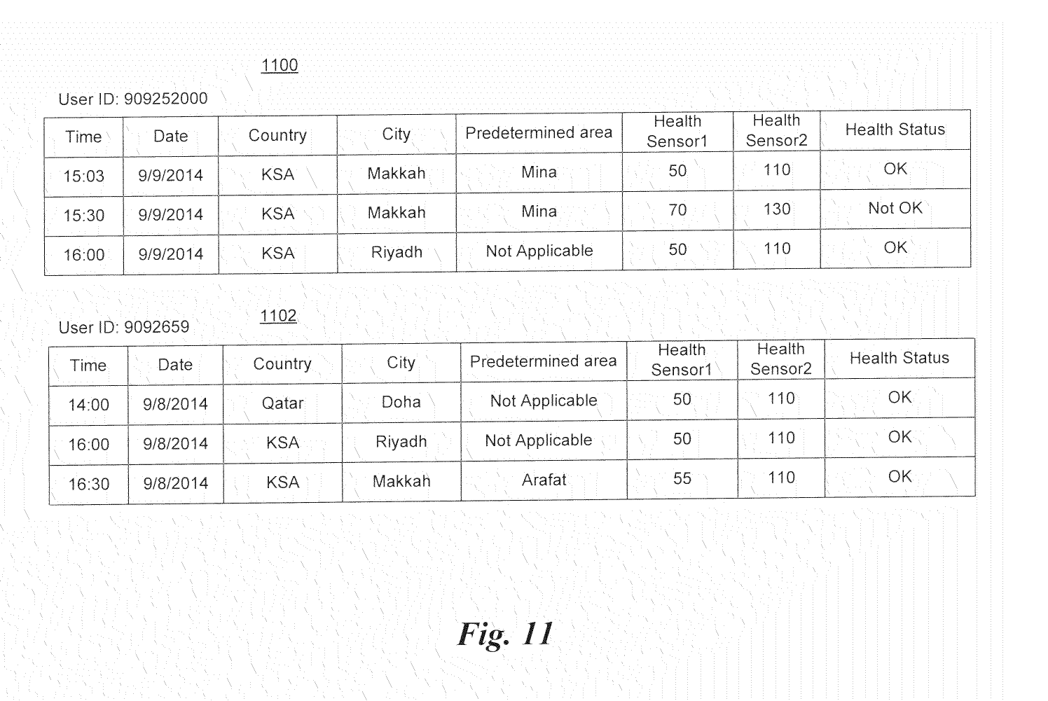

FIG. 11 shows exemplary user logs according to one example. The user log 1100, 1102 may be stored in the server 100. In one embodiment, the user log may include one or more of, but not limited to, a user identification number, the time, the date, a country, a city, the predetermined area name, readings from a first health sensor, readings from a second health sensor, and a health status. In selected embodiments, the user identification number may be a phone number associated with the mobile device 106. The user log 1100, 1102 may also be stored in the memory of the mobile device 106. The server 100 may store a plurality of user logs associated with the plurality of users. For example, 1100 shows the user in KSA in the city of Maccah on Sep. 9, 2014 in the predetermined area of “Mina”. In addition, the user log 1100 shows two health physiological readings from two health sensors. The processing circuitry may analyze the physiological readings from the health sensors to determine the health status. The processing circuitry may compare the health sensor physiological readings with predetermined values saved in the memory. In response to determining that the readings are not normal, the health status may be set to “Not OK”. In response to determining that the physiological readings are normal, the health status is set to “OK”. The user log also stores the country and the city where the user is located. In addition, the processing circuitry may check whether the user is currently located in the predetermined area. In response to determining that the user current location is in the predetermined area, the predetermined area name is stored in the user log. If the country or the city does not have predetermined areas, then “Not applicable” is stored in the user log.

In selected embodiments, the user may choose a set of authorized individuals such as the user's friends and family members. The user may save a list of the authorized individual's names in the server 100. In other embodiments, an individual may need to be authenticated in order to be added to the list of authorized individuals. The process of authenticating the individual may involve a mobile phone number, a full name and a country entered for example, in a registration page. The individual may then send a request to the user to be considered as an authorized individual. The user may then approve the request upon verification of the information. The individual is then added to the list of authorized individuals using the interface of the mobile device 106.

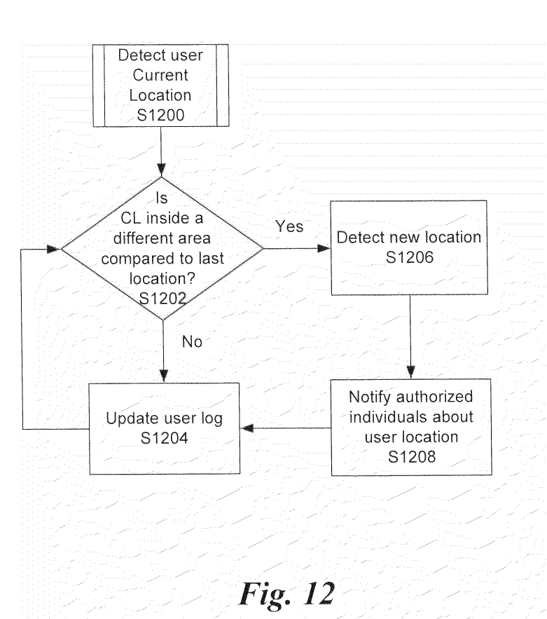

FIG. 12 is another exemplary flowchart to alert the authorized individuals. At S1200, the user location is detected. At Step S1202, the server checks whether the user location is within the boundaries of the last predetermined area stored in the user log 1100. In response to determining that, the user current location is not within the predetermined area stored in the user log, the server, at step S1206, determines the predetermined area that corresponds to the user current location. The processing circuitry may use table 400 to determine the predetermined area name. Then, at step S1208, the server sends an alert to the authorized individuals containing information about the name of the predetermined area where the user is located. Then, at step S1204, the user log 1100 is updated with the user location and the current time and date. In selected embodiments, the authorized individuals may notify a third party such as organizers and first responders in response to determining that the user is not in the predetermined area associated with the current date and time.

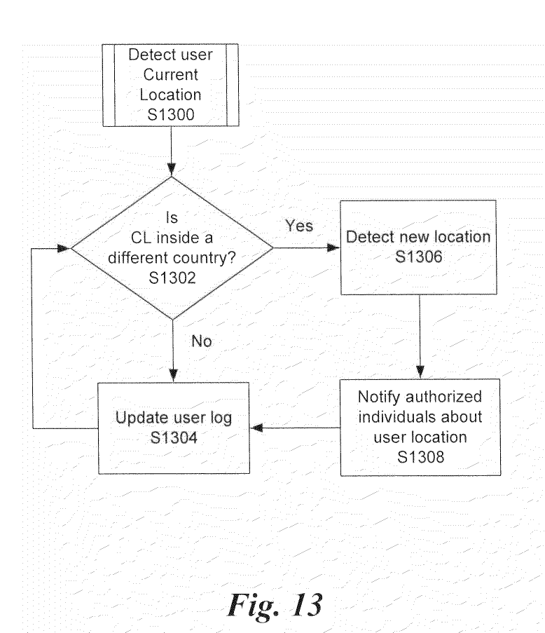

FIG. 13 is another exemplary flowchart to alert the authorized individuals. At S1300, the user location is detected. At Step S1302, the server checks whether the user location is within the boundaries of the last country stored in the user log 1100. In response to determining that the user current location is not within the boundaries of the last country stored in the user log, the server at step S1306 determine the country that corresponds to the user current location. Then, at step S1308, the server sends an alert to the authorized individuals containing information about the name of the country the user is currently in. Then, at step S1304, the user log 1100 is updated with the country and the current time and date.

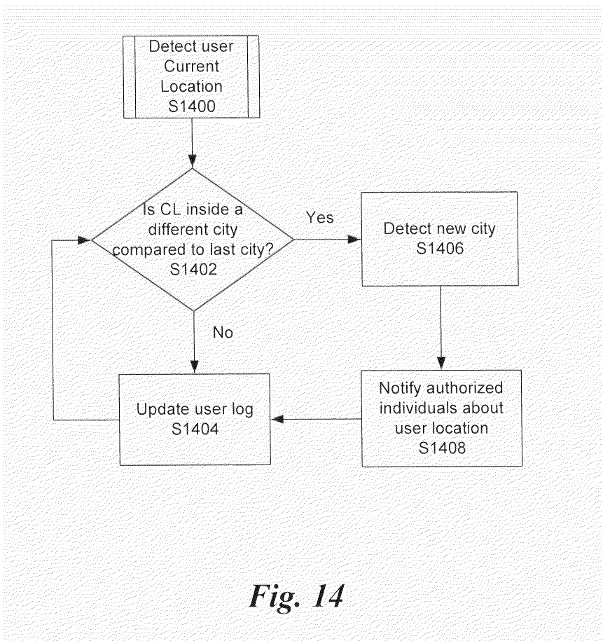

FIG. 14 is another exemplary flowchart to alert the authorized individuals. At S1400, the user location is detected. At Step S1402, the server checks whether the user location is within the boundaries of the last city stored in the user log 1100. In response to determining that the user current location is not within the boundaries of the last city stored in the user log, the server at step S1406 determine the city that corresponds to the user current location. Then, at step S1408, the server sends an alert to the authorized individuals containing information about the name of the city that corresponds to the user current location. Then, at step S1404, the user log 1100 is updated with the city name and the current time and date.

In selected embodiments, the authorized individuals may create additional conditions to receive an alert. For example, the authorized individuals may choose to get the alert in response to determining by the processing circuitry that the user is not at a particular area during a particular time. For example, the authorized individuals may choose to receive the alert in response to determining that the user is not in his hotel during nighttime. In another example, the authorized individuals may choose to receive the alert when the user leaves or enters a new country but not when the user leaves or enters a new city.

In selected embodiments, the authorized individuals may display the current location of the user on a map. The authorized individuals may also download from the server 100 via communication circuitry information related to the user. The information may include prayer time, weather and news related to the predetermined area. The user may limit access to certain information to selected authorized individuals.

In selected embodiments, the mobile device 106 may be further equipped with health sensors. The health sensors may detect a heartbeat, an electrocardiography (ECG), and a blood pressure. In other embodiments, the health sensors may be independent of the mobile device 106. Physiological readings from the health sensors may be transmitted, via the network 102, to the server 100.

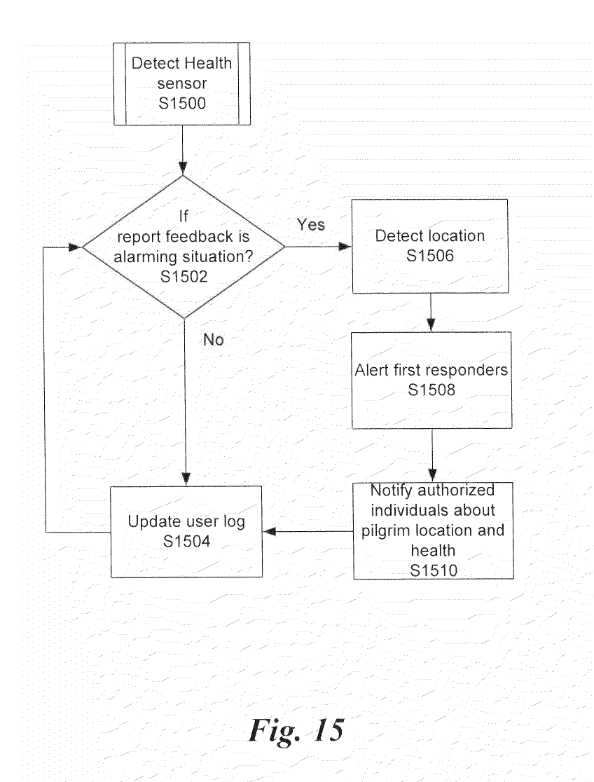

FIG. 15 is an exemplary flowchart to alert the authorized individuals about the user health status. At step S1502, the server 100 obtains the health sensors readings from the user mobile device 106 via the network 102. The server 100 then compares the health sensor physiological readings with normal values saved in the memory. The server 100 then determines the health status for the user as explained in FIG. 11. In response to determining that the health status of the user is “not OK”, the flow goes to step S1506. At step S1506, the server detects the user current location. At step S1508, the server 100 sends an alert to first responders via the network 102. The alert may notify the first responders about the user location and the current health sensor readings. Then, at step S1508, the server 100 may send the alert to the authorized individuals containing information about the user health status and current location. At step S1504, the information is updated in the user log 1100. The physiological readings from the health sensors may be obtained at a predetermined frequency. For example, the physiological readings may be obtained from the health sensors and transmitted to the server 100 every hour. The predetermined frequency may be set as a function of the user age. For example, the predetermined frequency may be set to one hour for an older user and set to three hours for a younger user. In selected embodiments, the predetermined frequency may be set as a function of the user overall health. For example, for a user in good health the physiological readings from health sensor may be obtained less frequently than for a user with health problems. In other embodiments, the physiological readings may be obtained from the health sensors in response to determining that the user location has changed. In selected embodiments, the authorized individuals may send a request to the server 100 to obtain physiological readings from the health sensors.

In other embodiments, the user and the authorized individuals may share text, image and audio with each other. In addition, the user may share geotagged photo, geotagged text, and geotagged audio and video with the authorized individuals. The user may also upload the geotagged photos to their social networks such as Facebook and twitter via the network 102.

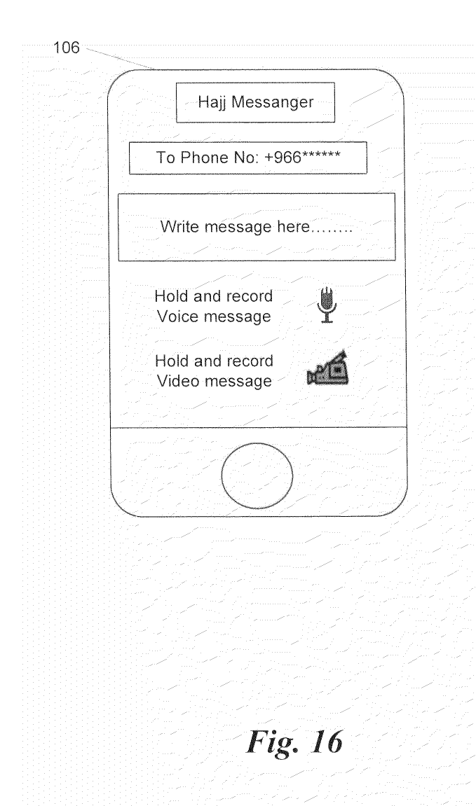

FIG. 16 is a diagram illustrating an exemplary user interface of the mobile device 106 using the boundary regulation detection method. The diagram shows an interface that may be used to communicate between the user and the authorized individuals. The user and the authorized individuals may use the interface to send text, voice, or video message.

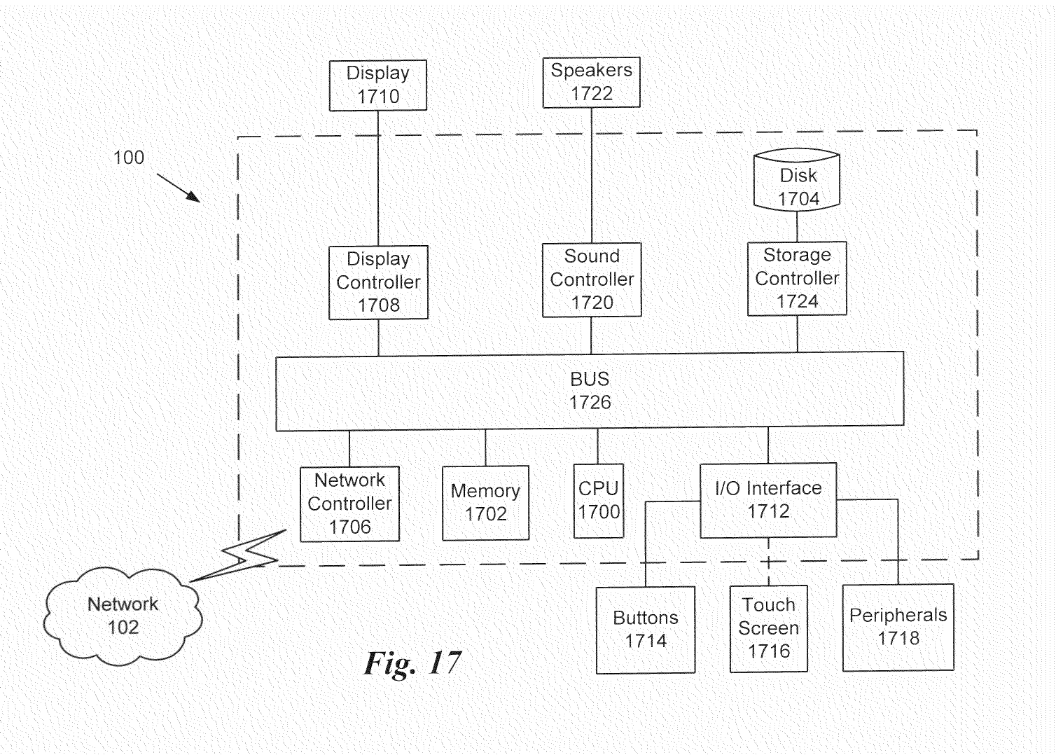

FIG. 17 is an exemplary block diagram of the server 100 according to one embodiment. In FIG. 17, the server includes a CPU 1700 which performs the processes described above. The server is assumed to handle big data as millions of pilgrims can check it, thereby generating a very large amount of location data communicating with the server at any given time. The process data and instructions may be stored in memory 1702. These processes and instructions may also be stored on a storage medium disk 1704 such as a hard disk drive (HDD) or portable storage medium or may be stored remotely. Further, the claimed advancements are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the mobile device communicates, such as a server or computer.

Further, the claimed advancements may be provided as a utility application, background daemon, or component of an operating system, or combination thereof, executing in conjunction with CPU 1700 and an operating system such as Microsoft Windows 7, UNIX, Solaris, LINUX, Apple MAC-OS and other systems known to those skilled in the art.

CPU 1700 may be a Xenon or Core processor from Intel of America or an Opteron processor from AMD of America, or may be other processor types that would be recognized by one of ordinary skill in the art. Alternatively, the CPU 1700 may be implemented on an FPGA, ASIC, PLD or using discrete logic circuits, as one of ordinary skill in the art would recognize. Further, CPU 1700 may be implemented as multiple processors cooperatively working in parallel to perform the instructions of the inventive processes described above.

The server in FIG. 17 also includes a network controller 1706, such as an Intel Ethernet PRO network interface card from Intel Corporation of America, for interfacing with network 102. As can be appreciated, the network 102 can be a public network, such as the Internet, or a private network such as an LAN or WAN network, or any combination thereof and can also include PSTN or ISDN sub-networks. The network 102 can also be wireless such as a cellular network including EDGE, 3G and 4G wireless cellular systems. The wireless network can also be WiFi, Bluetooth, or any other wireless form of communication that is known.

The server further includes a display controller 1708, such as a NVIDIA GeForce GTX or Quadro graphics adaptor from NVIDIA Corporation of America for interfacing with display 1710, such as a Hewlett Packard HPL2445w LCD monitor. A general purpose I/O interface 1712 interfaces with a keyboard and/or mouse 1714 as well as a touch screen panel 1716 on or separate from display 1710. General purpose I/O interface also connects to a variety of peripherals 1718 including printers and scanners, such as an OfficeJet or DeskJet from Hewlett Packard.

A sound controller 1720 is also provided in server, such as Sound Blaster X-Fi Titanium from Creative, to interface with speakers/microphone 1722 thereby providing sounds and/or music.

The general purpose storage controller 1724 connects the storage medium disk 1704 with communication bus 1726, which may be an ISA, EISA, VESA, PCI, or similar, for interconnecting all of the components of the mobile device. A description of the general features and functionality of the display 1710, keyboard and/or mouse 1714, as well as the display controller 1708, storage controller 1724, network controller 1706, sound controller 1720, and general purpose I/O interface 1712 is omitted herein for brevity as these features are known.

A system which includes the features in the foregoing description provides numerous advantages to users. In particular, the device helps pilgrims perform Hajj with a peace of mind and in a correct manner without worrying about boundary guidelines. Other Hajj guides didn't provide individualized alerts. Following the different boundaries guidelines can be confusing. The present disclosure addresses this concern by providing an easy method to guide and alert the users about various steps as required by religious laws (rituals). The system helps the friends and relatives of the pilgrim have peace of mind by checking on the pilgrim location and health status.

Obviously, numerous modifications and variations are possible in light of the above teachings. It is therefore to be understood that within the scope of the appended claims, the invention may be practiced otherwise than as specifically described herein.

Thus, the foregoing discussion discloses and describes merely exemplary embodiments of the present invention. As will be understood by those skilled in the art, the present invention may be embodied in other specific forms without departing from the spirit or essential characteristics thereof. Accordingly, the disclosure of the present invention is intended to be illustrative, but not limiting of the scope of the invention, as well as other claims. The disclosure, including any readily discernible variants of the teachings herein, define, in part, the scope of the foregoing claim terminology such that no inventive subject matter is dedicated to the public.

The above disclosure also encompasses the embodiments listed below.

(1) A method for implementing boundary regulation, including: storing, in a memory, a list of events; storing, in the memory, one or more dates and times corresponding to each event; storing, in the memory, one or more predetermined areas determined as a function of a particular event; determining, by processing circuitry, a user location; determining, by the processing circuitry, whether a current date and time corresponds with a date and time stored in the memory; generating an alert based on the user location in response to determining that the current date and time corresponds with the date and time; analyzing, by the processing circuitry, whether the user location is within a predetermined area corresponding to the event indicated by the date and time; and sending to authorized individuals the user location.

(2) The method for implementing boundary regulation of (1), further including: analyzing, by the processing circuitry, whether the user location is within a predetermined area corresponding to the event indicated by the date and time; and sending, in response to determining that the user location is not within the predetermined area, an alert to the authorized individuals indicating that the user is not within the predetermined area.

(3) The method for implementing boundary regulation of (1) or (2), further including: collecting, using health sensors, physiological readings; determining, by the processing circuitry, whether the physiological readings are normal by comparing the physiological readings to predetermined values stored in the memory; and sending, in response to determining that the physiological readings are not normal, an alert to the authorized individuals.

(4) The method for implementing boundary regulation of any one of (1) to (3), further including: storing, in the memory, a user log indicating at least one of a predetermined area, a country and a city based on the user location.

(5) The method for implementing boundary regulation of (4), further including: analyzing, by the processing circuitry, whether a current user location is within boundaries of the predetermined area indicated in the user log; and sending, in response to determining that the current user location is not within the boundaries of the predetermined area indicated in the user log, an alert to the authorized individuals.

(6) The method for implementing boundary regulation of (4), further including: analyzing, by the processing circuitry, whether a current user location is within boundaries of the country indicated in the user log; and sending, in response to determining that the current user location is not within the boundaries of the country indicated in the user log, an alert to the authorized individuals.

(7) The method for implementing boundary regulation of (4), further including: analyzing, by the processing circuitry, whether a current user location is within boundaries of the city indicated in the user log; and sending, in response to determining that the current user location is not within the boundaries of the city indicated in the user log, an alert to the authorized individuals.

(8) The method for implementing boundary regulation of any one of (1) to (7), wherein the authorized individuals access information about the user through a server.

(9) The method for implementing boundary regulation of (8), wherein the user restricts access to certain information to selected authorized individuals.

(10) The method for implementing boundary regulation of any one of (1) to (9), wherein the user and an authorized individual share at least one of a text, an image, and an audio message.

(11) The method for implementing boundary regulation of any one of (1) to (10), wherein boundaries of the predetermined areas are determined based on Islamic law.

(12) The method for implementing boundary regulation of any one of (1) to (11), wherein the events are religious events including at least one of Hajj and Umrah.

(13) The method for implementing boundary regulation of any one of (1) to (12), wherein the user location is determined by at least one of a satellite system and a cellular network.

(14) A system to implement boundary regulation, including: memory configured to store a list of events, store one or more dates and times corresponding to each event, and store one or more predetermined areas determined as a function of a particular event, and processing circuitry configured to determine a user location, determine whether a current date and time corresponds with a date and time stored in the memory, generate an alert based on the user location in response to determining that the current date and time corresponds with the date and time, analyze whether the user is within a predetermined area corresponding to the event indicated by the date and time, and send to authorized individuals the user location.

(15) The system to implement boundary regulation of (14), wherein boundaries of the predetermined areas are determined based on Islamic law.

(16) The system to implement boundary regulation of (14) or (15), wherein the events are religious events including at least one of Hajj and Umrah.

(17) A non-transitory computer readable medium storing computer-readable instructions therein which when executed by a computer causes the computer to perform a method for implementing boundary regulation, the method including: storing a list of events; storing one or more dates and times each corresponding to each event; storing one or more predetermined areas determined as a function of a particular event; determining a user location; determining whether a current date and time corresponds with a date and time stored in the memory; generating an alert based on the user location in response to determining that the current date and time corresponds with the date and time; analyzing whether the user location is within a predetermined area corresponding to the event indicated by the date and time; and sending, to authorized individuals, the user location.

1. A method for implementing boundary regulation, comprising:
storing, in a memory, a list of events;
storing, in the memory, one or more dates and times corresponding to each event;
storing, in the memory, one or more predetermined areas determined as a function of a particular event;
determining, by processing circuitry, a user location;
determining, by the processing circuitry, whether a current date and time corresponds with a date and time stored in the memory;
generating an alert based on the user location in response to determining that the current date and time corresponds with the date and time;
analyzing, by the processing circuitry, whether the user location is within a predetermined area corresponding to the event indicated by the date and time; and
sending to authorized individuals the user location.

2. The method of claim 1, further comprising:
analyzing, by the processing circuitry, whether the user location is within a predetermined area corresponding to the event indicated by the date and time; and
sending, in response to determining that the user location is not within the predetermined area, an alert to the authorized individuals indicating that the user is not within the predetermined area.

3. The method of claim 1, further comprising:
collecting, using health sensors, physiological readings;
determining, by the processing circuitry, whether the physiological readings are normal by comparing the physiological readings to predetermined values stored in the memory; and
sending, in response to determining that the physiological readings are not normal, an alert to the authorized individuals.

4. The method of claim 1, further comprising:
storing, in the memory, a user log indicating at least one of a predetermined area, a country and a city based on the user location.

5. The method of claim 4, further comprising:
analyzing, by the processing circuitry, whether a current user location is within boundaries of the predetermined area indicated in the user log; and
sending, in response to determining that the current user location is not within the boundaries of the predetermined area indicated in the user log, an alert to the authorized individuals.

6. The method of claim 4, further comprising:
analyzing, by the processing circuitry, whether a current user location is within boundaries of the country indicated in the user log; and
sending, in response to determining that the current user location is not within the boundaries of the country indicated in the user log, an alert to the authorized individuals.

7. The method of claim 4, further comprising:
analyzing, by the processing circuitry, whether a current user location is within boundaries of the city indicated in the user log; and
sending, in response to determining that the current user location is not within the boundaries of the city indicated in the user log, an alert to the authorized individuals.

8. The method of claim 1, wherein the authorized individuals access information about the user through a server.

9. The method of claim 8, wherein the user restricts access to certain information to selected authorized individuals.

10. The method of claim 1, wherein the user and an authorized individual share at least one of a text, an image, and an audio message.

11. The method of claim 1, wherein boundaries of the predetermined areas are determined based on Islamic law.

12. The method of claim 1, wherein the events are religious events including at least one of Hajj and Umrah.

13. The method of claim 1, wherein the user location is determined by at least one of a satellite system and a cellular network.

14. A system to implement boundary regulation, comprising:
memory configured to
store a list of events,
store one or more dates and times corresponding to each event, and
store one or more predetermined areas determined as a function of a particular event, and
processing circuitry configured to
determine a user location,
determine whether a current date and time corresponds with a date and time stored in the memory,
generate an alert based on the user location in response to determining that the current date and time corresponds with the date and time,
analyze whether the user is within a predetermined area corresponding to the event indicated by the date and time, and
send to authorized individuals the user location.

15. The system of claim 14, wherein boundaries of the predetermined areas are determined based on Islamic law.

16. The system of claim 14, wherein the events are religious events including at least one of Hajj and Umrah.

17. A non-transitory computer readable medium storing computer-readable instructions therein which when executed by a computer causes the computer to perform a method for implementing boundary regulation, the method comprising:
storing a list of events;
storing one or more dates and times corresponding to each event;
storing one or more predetermined areas determined as a function of a particular event;
determining a user location;
determining whether a current date and time corresponds with a date and time stored in the memory;
generating an alert based on the user location in response to determining that the current date and time corresponds with the date and time;
analyzing whether the user location is within a predetermined area corresponding to the event indicated by the date and time; and
sending to authorized individual the user location.
